(19) United States
(12) Patent Application Publication
(10) Pub. No.: US 2014/0352268 A1
(43) Pub. Date: Dec. 4, 2014

(54) CYCLONIC PARTICULATE COLLECTION DEVICE

(71) Applicant: Eric Wilson, Brampton (CA)

(72) Inventor: Eric Wilson, Brampton (CA)

(21) Appl. No.: 13/906,570

(22) Filed: May 31, 2013

(51) Int. Cl. B04C 3/06; B01D 50/00; B04C 9/00; B01D 45/08

(52) U.S. Cl. CPC B04C 3/06; B01D 45/08; B01D 50/002; B04C 9/00
USPC 55/337; 55/458; 55/436; 55/439; 55/437

(57) ABSTRACT

A lidded cylindrical container having an inlet duct having an intake for connecting to gas flow having particulate or liquid, and an outtake for directing the as flow downwardly and tangentially across a wail of the container. An outlet duct is integrally connected around the inlet duct and having an intake opening into the inside of the lidded cylindrical container and an outtake adapted to move the gas flow away from the particulate collection device leaving the particulate within the lidded cylindrical container. The cyclonic particulate collection device is secured to the lidded container through a single opening in the lidded cylindrical container.

### FIELD OF THE INVENTION

This invention relates in general to liquid, bulk solid and dust removal systems and more particularly to solid or liquid separation devices and auxiliary containers to receive liquids, dust, and other particles collected by removal systems such as shop vacuum cleaners using a cyclone separator which removes a liquid or solids from a gas stream.

### BACKGROUND OF THE INVENTION

Typical dust removal systems and shop vacuum cleaners draw air and waste through a hose into a waste collection chamber. In some cases the air is drawn through a filter, which catches most of the waste material and allows for relatively clean air to be exhausted. Limitations of these systems include the quantity of waste being collected and the types of waste collected. Attempts have been made to increase the effectiveness and quantity of waste such as sawdust that can be collected by drawing the air and collected debris first through or adjacent to an auxiliary waste collection receptacle into which some of the waste falls, thereby increasing the overall capacity of the system by the volume of the auxiliary receptacle.

Other systems include a cage fan that draws air and waste through the fan and into a sleeve-like structure, oriented vertically that empties into a cloth waste collection bag positioned below the structure. The air exits above the sleeve through the cloth bag which is inflated during use.

One example of these systems is disclosed in U.S. Pat. No. 6,210,457. U.S. Pat. No. 6,210,457 discloses a transparent molded plastic lid for use on an auxiliary trash collection container used with a shop vacuum cleaner or dust collector system that permits inspection of the container contents without removal of the lid. Specifically the lid has an inlet for attachment of the hose and a central outlet for the attachment of the hose. The inlet directs the incoming air now in a tangential manner towards the wall of the container and in a downward direction. However, the outlet is separate from the inlet and does not extend around the inlet pipe.

U.S. Pat. No. 7,282,074 is directed to an auxiliary dust collection system that can be interposed between a dust producing tool and a vacuum source such as a shop vacuum. The auxiliary system has a cyclonic separator connected by a flexible hose to the tool and by another hose to the vacuum source. An intake is arranged near the top of the conical body and is arranged to direct incoming air in a tangential manner in the conical body. A vortex pipe is centrally located on the top of the conical body and its upper outlet end is connected to an outlet hose.

Another example of a cyclonic dust collection system is shown in U.S. Pat. No. 6,833,016. In the dust collection station described therein, the air flow and entrained process dust are drawn through a cyclone separator disposed atop a storage drum or barrel. The process dust falls into a durable plastic film bag or liner in the barrel and the air then proceeds to a pumping and filtering arrangement, where the dust-free air is discharged back into the ambient environment. A means may be included to maintain a vacuum or negative pressure as a bag hold-down feature, to draw and hold the bag against the inside of the barrel. When the bag has been filled to its capacity, the bag can be tied off and lifted out, which eliminates the need to dump the barrel.

U.S. Pat. No. 6,027,541 to Siemers discloses a special lid for a conventional plastic trash can. The lid has inlet and outlet sockets for hoses, one coming from the dust producing tool and the other going to the shop vacuum. The air flow produces a cyclonic air movement, with the dust precipitating from the air flow in the trash can.

All of the above noted systems require multiple holes in which to connect both the inlet and outtake hoses.

### SUMMARY OF THE INVENTION

In accordance with one aspect of the present invention there is provided a cyclonic particulate collection device for a lidded cylindrical container having inlet duct having an intake for connecting to a gas flow having particulate or liquid, and at outtake for directing the gas flow downwardly and tangentially along a wall of the container. An outlet duct is integrally connected around the inlet duct and having an intake opening into the inside of the lidded cylindrical container and an outtake adapted to move the gas flow away from the particulate collection device leaving the particulate within the lidded cylindrical container. The cyclonic particulate collection device is secured to the lidded container through a single opening in the lidded cylindrical. container.

Conveniently, the inlet duct outtake is a downwardly extending curved pipe positioned proximally to the wail of the container causing gas flow in either a counter clockwise or clockwise direction. The outtake may also be placed near flush against the wall of the container or adjacent to the wall of the container.

The outlet duct intake further may include a deflector member to help direct any floating particulate or liquid down into the container. The outlet duct intake may also include a filter or a trap to reduce particulate from entering the outlet duct intake.

Preferably, the container is cylindrical such as a paint pail or barrel. The opening may be in the lid of the container or in the side of the container. The device may also be secured to the container with a number of snap fittings and locking devices.

Advantages of the present invention include that the device only requires a single opening in the container and that the device has the ability to separate both liquids and particulates. A variety or containers may be used that have a lid and a single opening near the end therefore does not require any special vessel.

### BRIEF DESCRIPTION OF THE DRAWINGS

A detailed description of the preferred embodiments is provided herein below by way of example only and with reference to the following drawings, in which:

FIG. 1 in a perspective view, illustrates a cyclonic particulate collection device for a lidded container in accordance with a preferred embodiment of the present invention;

FIG. 2 in a top perspective view, illustrates the cyclonic particulate collection device for a lidded container of FIG. 1 mounted on the lidded container.

FIG. 3 in a bottom perspective view, illustrates the cyclonic particulate collection device for a lidded container of FIG. 1 mounted on the lidded container.

FIG. 4a in a side plan view, illustrates the cyclonic particulate collection device for a lidded container of FIG. 1

FIG. 4b in a cross-section view along the lines 4B-4B, illustrates the cyclonic particulate collection device for a lidded container of FIG. 1.

FIG. 5 in a top plan view, illustrates the cyclonic particulate collection device for a lidded container of FIG. 1.

FIG. 6 in a bottom plan view, illustrates the cyclonic particulate collection device for a lidded container of FIG. 1.

In the drawings, preferred embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

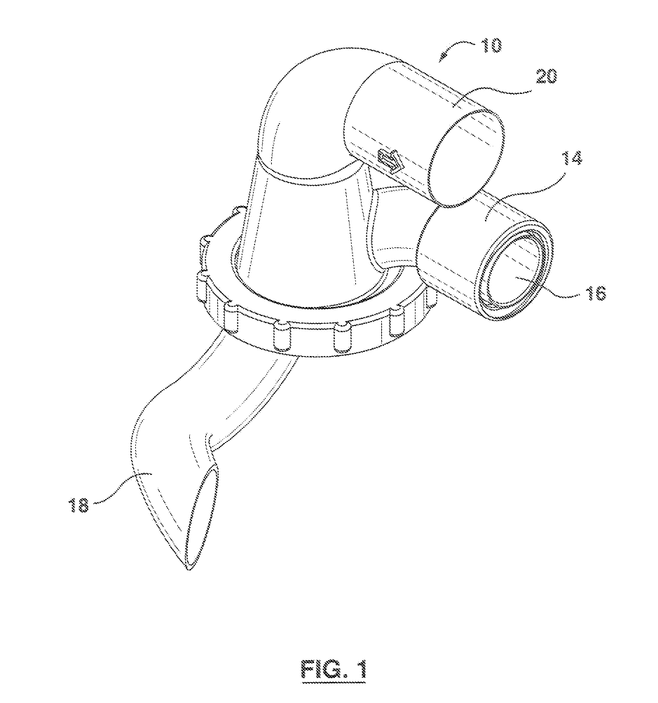

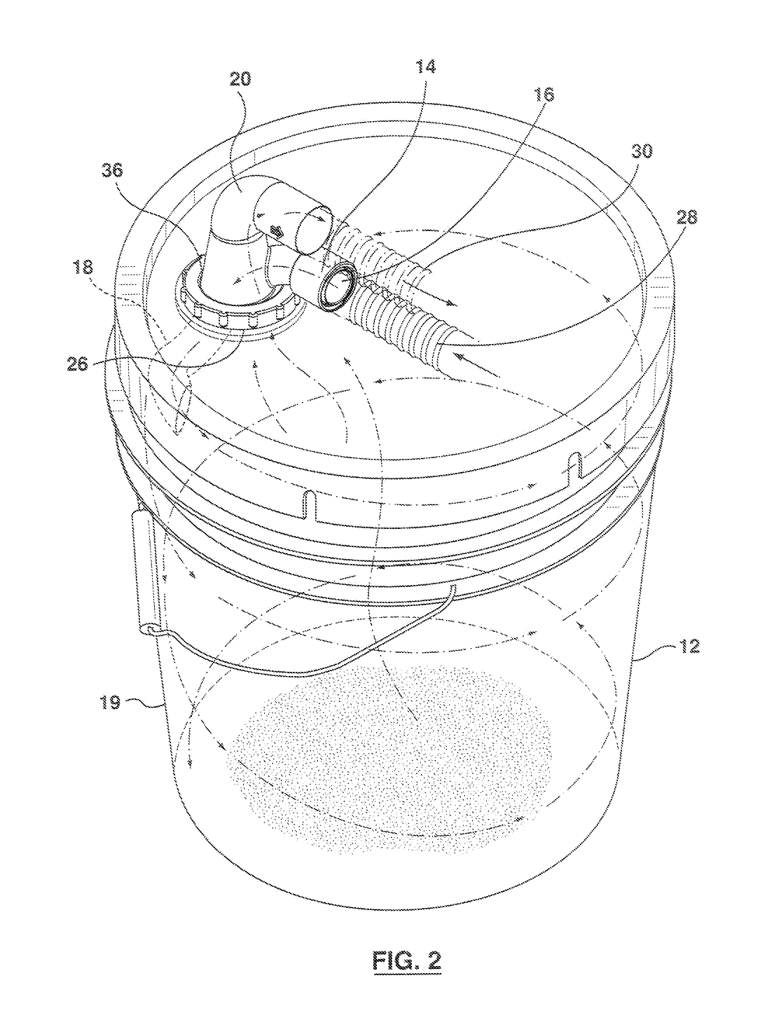

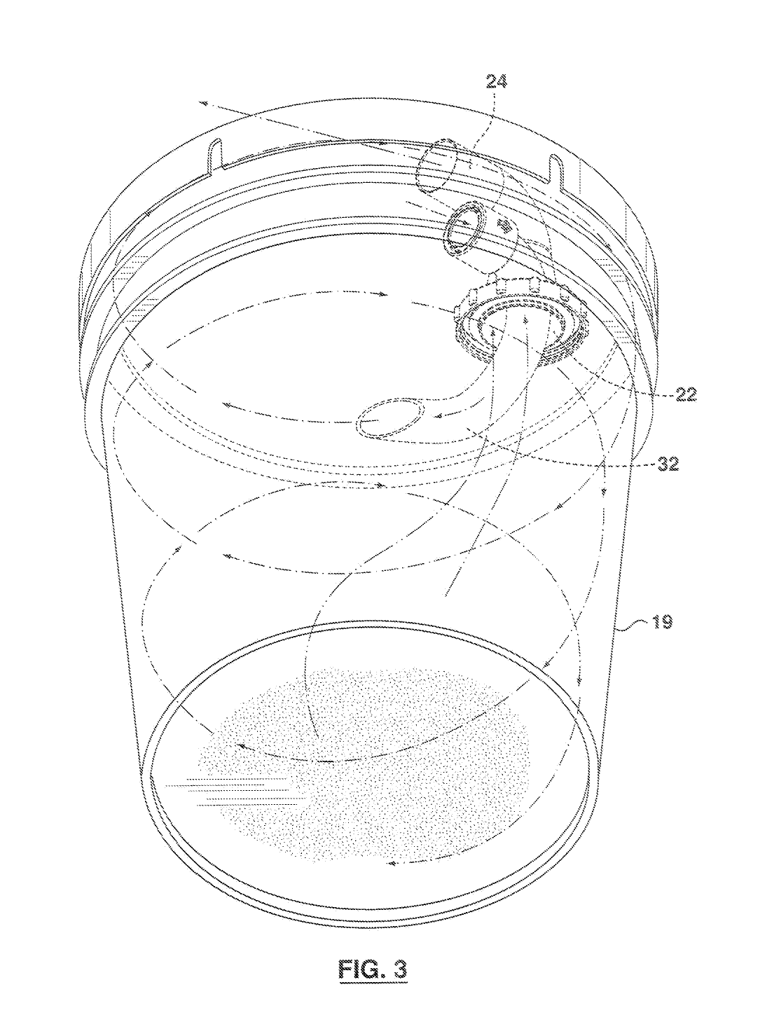

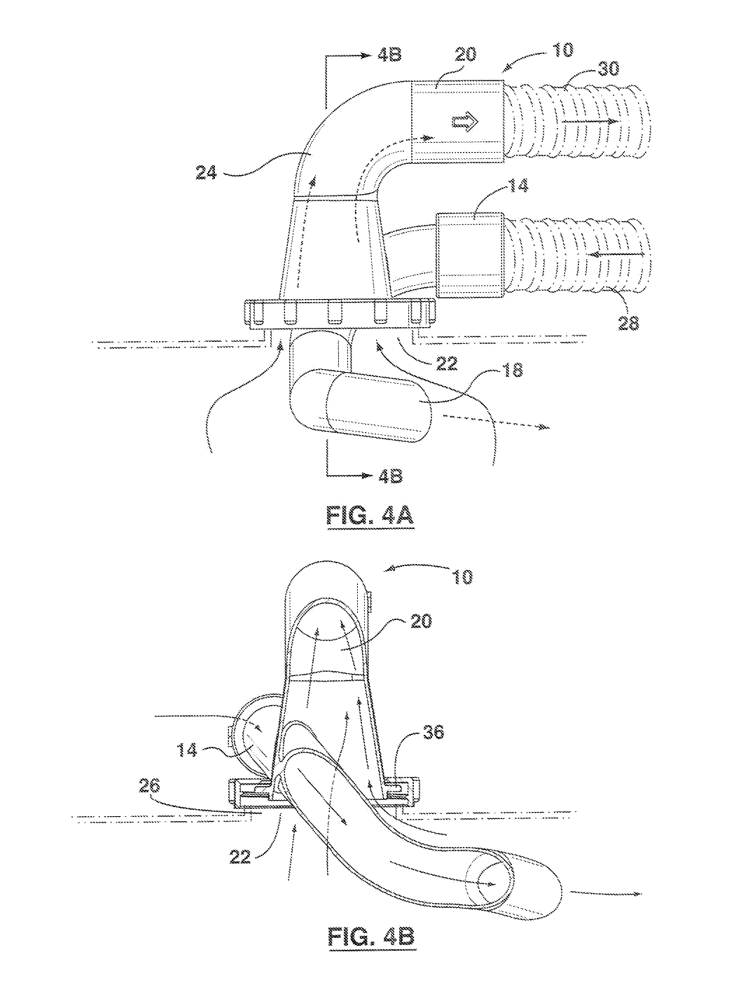

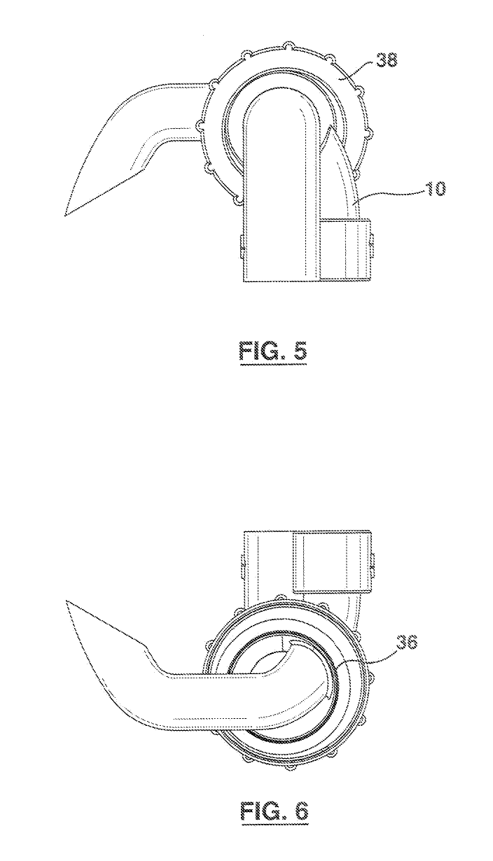

Referring to FIGS. 1 to 6, there is illustrated, a cyclonic particulate collection device 10 for a lidded cylindrical container in accordance with a preferred embodiment of the present invention. The cyclonic particulate collection device 10 for a lidded cylindrical container 12 includes an inlet duct 14 having an intake 16 for connecting to a gas flow having particulate or liquid, and an outtake 18 extending downward into the container 12 for directing the gas flow downwardly and tangentially across a wall 19 of the container 12.

The device 10 further includes an outlet duct 20 integrally connected around the inlet duct 14 and having an intake 22 opening into the inside of the lidded container 12 and an outtake 24 adapted to move the gas flow away from the cyclonic particulate collection device 10 leaving all of the particulate or liquid within the lidded cylindrical container 12. The cyclonic particulate collection device 10 is secured to the lidded cylindrical container 12 through a single opening 26 in the lidded cylindrical container

The inlet duct 14 and more specifically the intake 16 generally connects to a hose 28 or duct that allows for the gas which may contain liquid or particulate into the container 12. The outtake 24 of the outlet duct 20 generally connects to a hose 30 or duet allowing gas out of the container 12.

The outtake 18 of the inlet duct 14 may be shaped to direct the gas flow such that it is generally tangential to the inside wall 19 of the container 12. The inlet duct outtake 18 may be a downwardly extending curved pipe 32 positioned proximally to the wall 19 of the container 12. The outtake 18 of the inlet duct 14 may also be positioned and shaped to be near flush and or adjacent the inside wall 19 of the container 12.

The positioning of the downwardly extending curved pipe 32 is adjustable, The gas flow can be directed in a clockwise or anticlockwise direction.

The outlet duct 20 and more specifically intake 22 is directly open to the inside of the container 12. The intake 22 may also be a downwardly extending pipe (not shown) that extends down into the center of the container where the gas flow inherently has less residual particulate. The device 10 can include a filter (not shown) mounted to the intake 22 or to the end of the pipe to stop residual particulate from entering the intake 22 of the outlet duct 20. The intake 22 may also include a screen to help stop residual particulate from entering the intake 22. The intake 22 can also include a deflector (not shown) that may be attached at the bottom of the pipe to direct residual particulate away from gas flow exiting through the intake 22 and ultimately the outtake 24. Finally the intake 22 may also include a trap at the end of the intake 22 pipe. The trap may be used to collect any excessive or residual particulate that is near the intake 22.

The device 10 further includes a pliable engagement member 36 that deflects allowing the device 10 to snap fit into the single opening 26. The engagement member 36 allows for a seal between the device 10 and the container 26. The engagement member 36 may be an elastomeric gasket that provides deflection and a seal between the device 10 and the container 12. The device 10 may further include a moveable locking mechanism 38 positioned on the lidded container 10 and is adapted to engage the engagement member 36 so as to secure the device tightly to the container 12. The movable locking mechanism 38 is a threaded nut that engages the device 10.

The device 10 further includes one or more of connecting hoses, ducts, or vessels 28 that have a first end that is connected to the inlet duct 14 and a second end that is connected to a blower, vacuum, or other gas movement device (not shown). The connecting hoses, ducts or vessels allow for the transfer of the particulate or liquid to be gathered by the device 10 through the inlet duct and into the container 12.

The device 10 further includes one or more of connecting hoses, ducts, or vessels 30 having a first end connected to the outlet duct 20 and a second end connected to a blower, vacuum, or other gas movement device. The connecting hoses, ducts or vessels allow for the gas to exit the device while leaving the particulate or liquid within the container 12.

In the illustration, the cylindrical container 12 shown is a paint pail, but can be any container such as a water barrel, chemical drum, etc., with at least one opening at a suitable location such as on the top of the lid or on the side of the container 12. The present invention only requires a single opening 26 to accommodate the insertion and securement of the device 10.

Typically a used paint pail may be used as the cylindrical container 12 which typically includes a lid having a single opening 26. In this example the single opening 26 is already provided thereby net requiring any change to the existing, cylindrical container 12. This makes for easy insertion of the device 10 into the container without having to make any modifications to the container thereby saving time and cost. Furthermore by keeping the integrity of the original container 12, the seal using the ready-made opening 26 with the instant device 10, is superior to typical requirements of having to make a second man-made opening to accommodate both the intake and outtake ducts.

Multiple devices 10 may be used in tandem such that the first device 10 removes most of the particulate and the second device assembly provides additional particulate removal.

In operation, a used paint pail having a lid with a single opening is used as the cylindrical container 12. The device 10 is inserted into the already existing opening 26 in the lid of the container 12. The engagement member 36 engages the opening 26 and so that the device 10 is inserted into the container 12 and rests on the sides of the opening 26 of the lid. The outtake 18 of the inlet duct 14 may then be positioned near or against the wall of the container 12. The movable locking mechanism 38 or threaded nut is then tightened down thereby engaging the engagement member 36 sealing the device to the lid of the container 12.

Once a secure seal has been determined, the connecting hoses connected to a vacuum, for example, may be connected to the intake 16 of the inlet duct 14. Once the connecting hoses have been connected, the vacuum may be activated and the transfer of particulate or liquid within the gas flow can begin. The liquid or particulate is then pulled into the device 10 via the inlet duct 14 through the intake 16 and flows through to the outtake 18 of the inlet duct 14. The particulate or liquid is forced tangentially along the wall of the container 12.

The forcing of the particulate or liquid tangentially along the wall causes the particulate or liquid to fall or be pushed down into the bottom of the container. As a result the liquid or particulate is separated from the gas at an effective rate. Gravity also aids in the collecting of the particulate in the bottom of the container.

Once the particulate or liquid has been removed from the air flow, the air flows up and out from the container 12 via the intake 22 of the outlet duct 20. The expelled air then moves through the outtake 24 of the outlet duct 20 and along the connecting hoses and vented to the outside environment via a blower by way of example.

The exiting air flow can pass over a deflector, filter or trap or any combination thereof to capture any residual particulate in the air flow to provide increased performance. The device 10 can vary performance depending on the gas velocity, flow conditions and particulate characterization within the container 12.

Other variations and modifications of the invention are possible. All such modifications or variations are believed to be within the sphere and scope of the invention as defined by the claims appended hereto.

I claim:

1. A cyclonic particulate collection device for a lidded cylindrical container comprising:
a. an inlet duct having an intake for connecting to a gas flow having particulate or liquid, and an outtake for directing the gas flow downwardly and tangentially along a wall of the container; and
b. an outlet duct integrally connected around the inlet duct and having an intake opening into the inside of the lidded container and an outtake adapted to move the gas flow away front the cyclonic particulate collection device leaving the particulate or liquid within the lidded cylindrical container.,
wherein the cyclonic particulate collection device is secured to the lidded cylindrical container through a single opening in the lidded cylindrical container.

2. A cyclonic particulate collection device for a lidded cylindrical container as claimed in claim 1 wherein the inlet duct outtake is a downwardly extending curved pipe positioned proximally to the wall of the container causing gas flow in either a counter clockwise or clockwise direction.

3. A cyclonic particulate collection device for a lidded cylindrical container as claimed in claim 2 wherein the inlet duct outtake is a downwardly extending curved pipe positioned near flush to the wall of the container causing gas flow in either a counter clockwise or clockwise direction.

4. A cyclonic particulate collection device for a lidded cylindrical container as claimed in claim 2 wherein the inlet duct outtake is a downwardly extending curved pipe positioned adjacent to the wall of the container causing gas flow to move along and across the will of the container in either a counter clockwise or clockwise direction.

5. A cyclonic particulate collection device for a lidded cylindrical container as claimed in claim 1 wherein the outlet duct intake further includes a deflector member to reduce matter from entering the outlet duct intake.

6. A. cyclonic particulate collection device for a lidded cylindrical container as claimed in claim 1 wherein the outlet duct intake further includes a filter.

7. A cyclonic particulate collection device for a lidded cylindrical container as claimed in claim 1 wherein the outlet duct intake further includes a screen.

8. A cyclonic particulate collection device for a lidded cylindrical container as claimed in claim 1 wherein the intake opening of the outlet duct further comprises a trap for collecting particulate.

9. A cyclonic particulate collection device for a lidded cylindrical container as claimed in claim 1 wherein the single opening is in the top of the lidded cylindrical container.

10. A cyclonic particulate collection device tor a lidded cylindrical container as claimed in claim 1 wherein the single opening is in the side of the lidded cylindrical container.

11. A cyclonic particulate collection device for a lidded cylindrical container as claimed in claim 1 further comprising a pliable engagement member that deflects allowing the device to snap fit into the single opening.

12. A cyclonic particulate collection device for a lidded cylindrical container as claimed in claim 11 further comprising a moveable locking mechanism adapted for the securement of the engagement member.

13. A cyclonic particulate collection device for to lidded cylindrical container as claimed in claim 12 wherein the movable locking mechanism is a threaded nut that engages the device.

14. A cyclonic particulate collection device for a lidded cylindrical container as claimed in claim 1 further comprising one or more of connecting hoses, ducts. or vessels paving a first end connected to the inlet duct and a second end connected to a blower, vacuum, or other gas movement device.

15. A cyclonic particulate collection device for a lidded cylindrical container as claimed in claim 1 further comprising one or more of connecting hoses, ducts, or vessels having a first end connected to the outlet duct and a second end connect to a blower, vacuum, or other gas movement device.

16. A cyclonic particulate collection device for a lidded cylindrical container as claimed in claim 1 wherein the outlet duct intake is a downwardly extending pipe positioned towards the centre of the lidded cylindrical container.

17. A cyclonic particulate collection device for a lidded cylindrical container as claimed in claim 1 wherein the outlet duct intake can have multiple positions to change the direction of gas flow within the lidded cylindrical container.
